(19) United States
(12) Patent Application Publication
(10) Pub. No.: US 2025/0271173 A1
(43) Pub. Date: Aug. 28, 2025

(54) FLUID HEATING DEVICE FOR VEHICLE

(71) Applicant: Panasonic Automotive Systems Co., Ltd., Kanagawa (JP)

(72) Inventors: Masato MORIKAWA, Shiga (JP); Masaki HANADA, Aichi (JP); Atsushi HIROTA, Shiga (JP)

(21) Appl. No.: 19/047,229

(22) Filed: Feb. 6, 2025

(30) Foreign Application Priority Data
Feb. 26, 2024 (JP) 2024-026181

(51) Int. Cl. F24H 1/00; F24H 9/02; F24H 9/20

(52) U.S. Cl. CPC F24H 1/009; F24H 9/02; F24H 9/2007

(57) ABSTRACT

A fluid heating device for a vehicle includes: a tank that includes a flow path that directs a fluid; a heating unit that heats the fluid by heating the tank; and a case that houses the tank and the heating unit.

### CROSS REFERENCE TO RELATED APPLICATION

The present application is based on and claims priority of Japanese Patent Application No. 2024-026181 filed on Feb. 26, 2024.

### FIELD

The present disclosure relates to a fluid heating device for a vehicle.

### BACKGROUND

Patent Literature (PTL) 1 discloses a fluid heating device that heats a fluid. The fluid heating device includes: a heater unit that includes a heater that generates heat and a heating unit that is heated by the heater; and a case that houses the heating unit and in which a fluid for heat exchange with the heating unit flows.

### CITATION LIST

### Patent Literature

PTL 1: Japanese Unexamined Patent Application Publication No. 2017-89915

### SUMMARY

However, the fluid heating device according to PTL 1 can be improved upon.

In view of this, the present disclosure provides a fluid heating device for a vehicle capable of improving upon the above related art.

A fluid heating device for a vehicle according to one aspect of the present disclosure includes: a tank that includes a flow path that directs a fluid; a heating unit that heats the fluid by heating the tank; and a case that houses the tank and the heating unit.

A fluid heating device for a vehicle according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of a fluid heating device for a vehicle according to an embodiment.

FIG. 2 is an exploded perspective view of the fluid heating device for the vehicle according to the embodiment.

FIG. 3 is a plan view illustrating a state in which a tank is inserted to a case.

FIG. 4 is a lateral view of the fluid heating device for the vehicle according to the embodiment.

FIG. 5 is a cross-sectional view of the fluid heating device for the vehicle taken along line V-V in FIG. 1.

### DESCRIPTION OF EMBODIMENT

Hereinafter, an embodiment will be specifically described with reference to the drawings.

It should be noted that the embodiment described below shows a general or specific example. The numerical values, shapes, materials, structural elements, arrangement positions and connection forms of the structural elements, and the like shown in the following embodiment are examples, and are not intended to limit the present disclosure. Moreover, among the structural elements in the embodiment below, the structural elements not described in independent claims will be described as arbitrary structural elements.

Note that the respective figures are schematic diagrams and are not necessarily precise illustrations. Additionally, the structural elements that are essentially the same share like reference numerals in the respective figures.

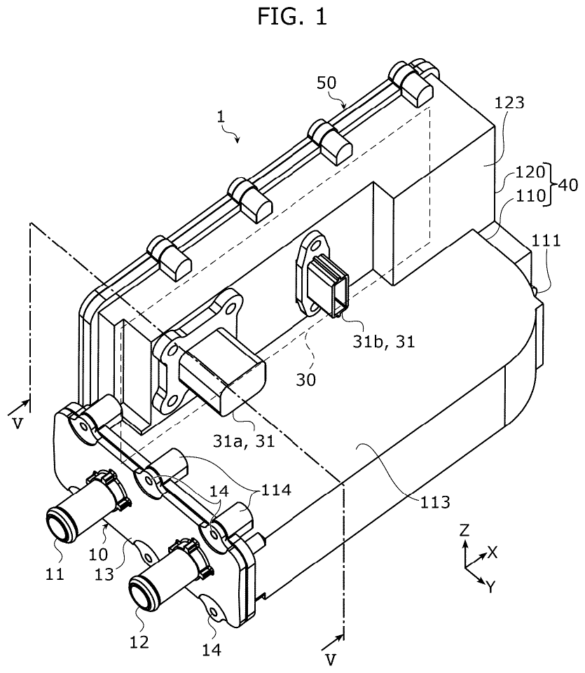

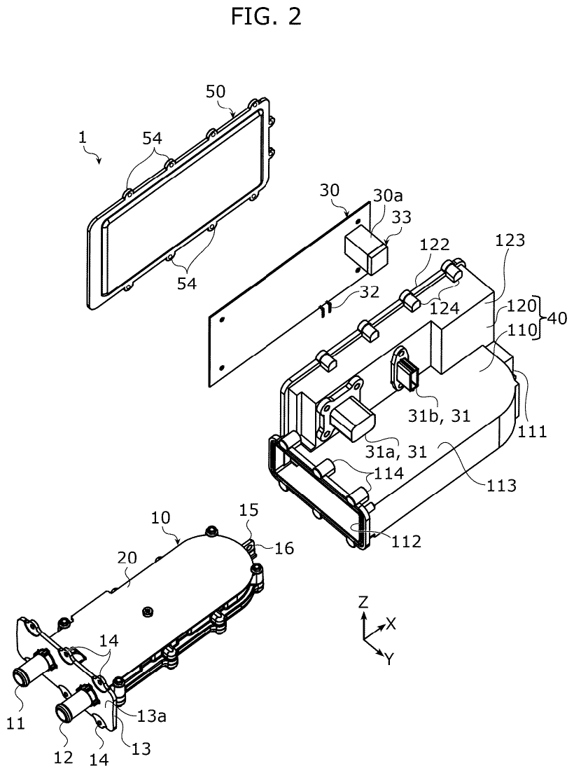

Moreover, in the embodiment described below, in FIG. 1, a positive X-axis direction is defined as the direction in which a tank is inserted into a first opening, a positive Y-axis direction is defined as the direction of a circuit board relative to the cover, and a positive Z-axis direction is defined as the direction perpendicular to the positive X-axis direction and the positive Y-axis direction, and the direction of a second housing relative to a first housing. The directions in FIG. 1 may be applied to FIG. 2 and subsequent figures.

Moreover, in the embodiment described below, the expressions such as “X-axis direction” and “elongated” are used. For example, “X-axis direction” not only means being perfectly X-axis direction, and “elongated” not only means being perfectly elongated, but also mean being substantially X-axis direction and being substantially elongated, that is, mean a state including an error of, for example, approximately several percent. In addition, “X-axis direction” and “elongated” respectively mean being X-axis direction and elongated to the extent that the effects of the present disclosure can be achieved. The same applies to expressions using other direction and shape.

### Embodiment

First, a configuration of fluid heating device 1 for a vehicle will be described with reference to FIG. 1 to FIG. 5.

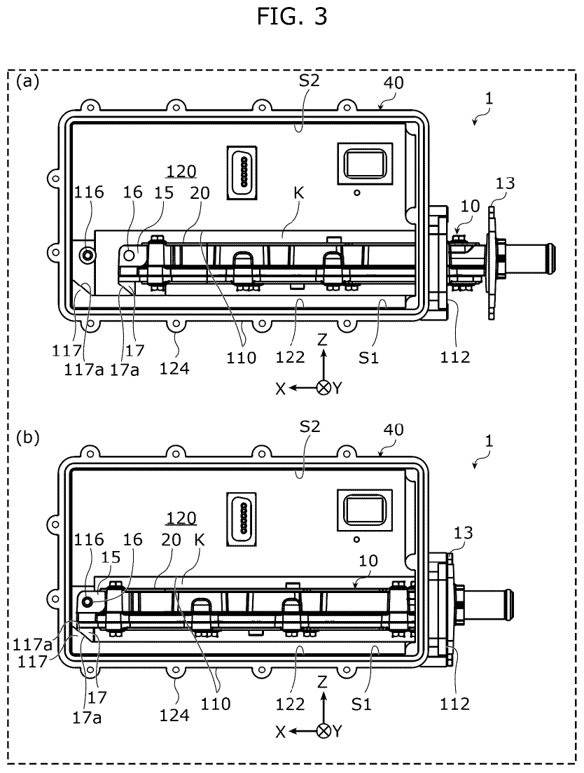

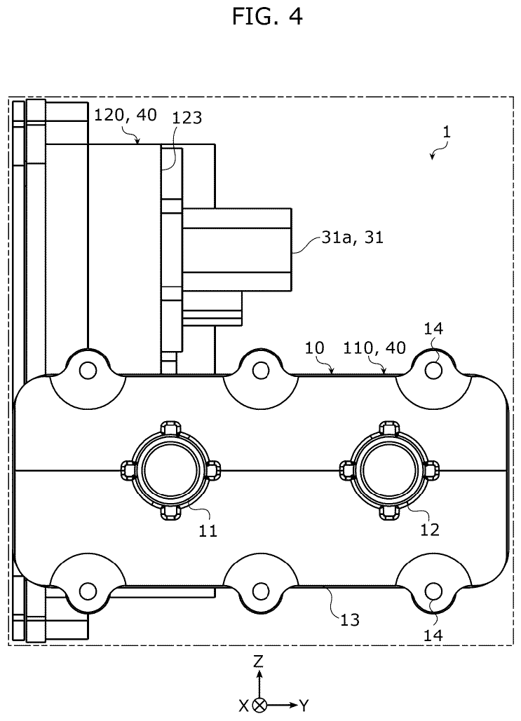

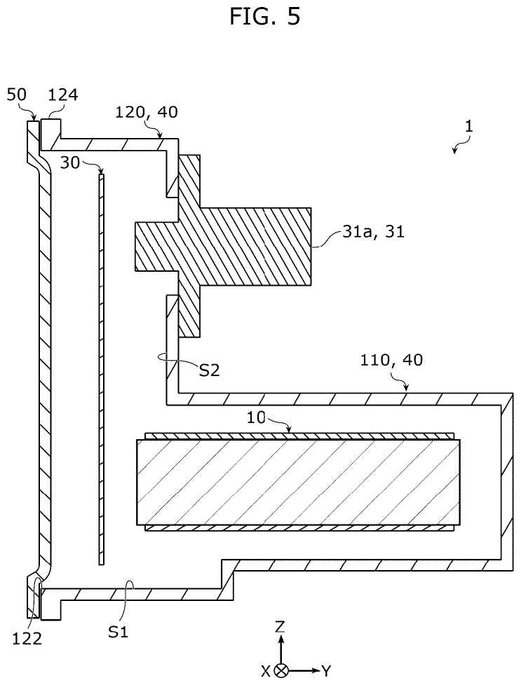

FIG. 1 is a perspective view of fluid heating device 1 for a vehicle according to an embodiment. FIG. 2 is an exploded perspective view of fluid heating device 1 for the vehicle according to the embodiment. FIG. 3 is a plan view illustrating a state in which tank 10 is inserted into case 40. FIG. 4 is a lateral view of fluid heating device 1 for the vehicle according to the embodiment. FIG. 5 is a cross-sectional view of fluid heating device 1 for the vehicle taken along line V-V in FIG. 1.

As illustrated in FIG. 1, fluid heating device 1 for the vehicle is applied to vehicle air conditioning devices, vehicle batteries, and the like mounted in vehicles, such as EVs (Electric Vehicles), HEVs (Hybrid Electric Vehicles), and PHEVs (Plug-in Hybrid Electric Vehicles). When fluid heating device 1 for the vehicle is applied to a vehicle air conditioning device, for example, fluid heating device 1 for the vehicle heats the fluid when the vehicle air conditioning device performs a heating operation. This allows the vehicle air conditioning device to deliver warm air into the vehicle cabin.

As illustrated in FIG. 1 and FIG. 2, fluid heating device 1 for the vehicle includes tank 10, heating unit 20, circuit board 30, case 40, and cover 50.

Tank 10 is slim and elongated. Specifically, tank 10 is a container that is slim in the Z-axis direction and elongated in the X-axis direction. In other words, tank 10 is a container that is in a shape of a flat plate that is parallel to the XY plane.

Tank 10 may include a flow path therein for directing the fluid. Specifically, tank 10 includes supply port 11 through which the fluid is supplied from the outside into tank 10 and discharge port 12 through which the fluid that has passed through the flow path of tank 10 is discharged to the outside. Supply port 11 and discharge port 12 are aligned on lid 13 of tank 10 along the Y-axis direction. Each of supply port 11 and discharge port 12 is a connection port that can be connected to a hose (not illustrated). Hoses are connected to supply port 11 and discharge port 12, allowing the fluid to flow in and out of tank 10. The fluid is, for example, a liquid such as a coolant.

Lid 13 is disposed at the end portion of tank 10 in the negative X-axis direction, and is integrated with tank 10. The term “integrated” means that lid 13 and tank 10 cannot be separated from each other without destroying lid 13 and tank 10.

Heating unit 20 is disposed in tank 10. Heating unit 20 is a heater, and is capable of heating tank 10. With this, the fluid supplied through supply port 11 of tank 10 is heated by heating unit 20 as the fluid passes through tank 10, and the heated fluid can be discharged through discharge port 12.

Circuit board 30 is in a shape of a plate elongated along the X-axis direction, and is held in case 40 so as to be parallel to the XZ plane.

Circuit board 30 is capable of driving and controlling heating unit 20. Circuit board 30 is capable of adjusting the temperature, heating period and the like of the fluid in tank 10 by driving and controlling heating unit 20.

Case 40 houses tank 10, heating unit 20, and circuit board 30. Case 40 is elongated in the X-axis direction, and is L-shaped when viewed along the X-axis direction. Case 40 is, for example, made of a metal material.

Specifically, case 40 includes: elongated first housing 110 that houses elongated tank 10; and second housing 120 that is elongated along the longitudinal direction of first housing 110, connected to first housing 110, and extends in the direction intersecting first housing 110.

First housing 110 is slim in the Z-axis direction and elongated in the X-axis direction so as to house tank 10. In other words, first housing 110 is a container that is parallel to the XY plane.

First housing 110 includes first opening 112 at a first longitudinal end portion of first housing 110. First opening 112 is open to allow tank 10 to be inserted. First opening 112 is positioned on the negative X-axis side of first housing 110. This allows tank 10 to be inserted into first opening 112 of first housing 110 along the positive X-axis direction.

First housing 110 includes first bottom portion 111 at a second longitudinal end portion of first housing 110. First bottom portion 111 serves as a bottom wall of first housing 110 on the positive X-axis side when tank 10 is inserted into first opening 112 of first housing 110.

As illustrated in (a) and (b) of FIG. 3, first guide portion 117 is disposed on first bottom portion 111. Tank 10 includes second guide portion 17 at front end portion 15 in the direction of insertion into first opening 112. Front end portion 15 of tank 10 is the end portion of tank 10 on the positive X-axis side. First guide portion 117 includes inclined surface 117a that is inclined upward toward the positive X-axis direction. Second guide portion 17 includes inclined surface 17a that is inclined downward toward the negative X-axis direction. Therefore, when tank 10 is inserted into first opening 112, second guide portion 17 on front end portion 15 of tank 10 is engaged with first guide portion 117 of first bottom portion 111, so that second guide portion 17 abuts the surface of first guide portion 117 and positioning is achieved. In such a manner, first guide portion 117 is capable of guiding second guide portion 17 of tank 10 inserted through first opening 112.

First bottom portion 111 includes first fastened portion 116 for fastening to tank 10. As illustrated in FIG. 2 and FIG. 3, tank 10 includes first fastening portion 16 at front end portion 15 of tank 10 in the direction of insertion into first opening 112. When tank 10 is inserted into first opening 112 and second guide portion 17 is guided to first guide portion 117, positioning of first fastening portion 16 and first fastened portion 116 are achieved so that first fastening portion 16 and first fastened portion 116 can be fastened.

In the present embodiment, first fastening portion 16 and first fastened portion 116 are fastened by a screw, bolt, or the like. Each of first fastening portion 16 and first fastened portion 116 may be, for example, a claw-shaped fastening structure. Moreover, one of first fastening portion 16 or first fastened portion 116 may be a claw-shaped fastening structure, and the other of first fastening portion 16 or first fastened portion 116 may be a hole for hooking the claw. Other known configurations may be used as long as first fastening portion 16 and first fastened portion 116 can be fastened.

Heating unit 20 is disposed in tank 10. When tank 10 is housed in first housing 110, heat insulation layer K is provided between heating unit 20 and the inner wall surface of first housing 110. Heat insulation layer K is, for example, a heat insulation material or an air layer provided between heating unit 20 and the inner wall surface of first housing 110. When heat insulation layer K is a heat insulation material, a heat insulation material may be pasted to the inner wall surface of heating unit 20 or first housing 110. In the present embodiment, heat insulation layer K is an air layer. Therefore, heating unit 20 and first housing 110 are spaced apart from each other to avoid contact between heating unit 20 and first housing 110.

As illustrated in FIG. 2, first housing 110 is elongated along the longitudinal direction of tank 10, and includes first wall portion 113 that is connected to second housing 120. First wall portion 113 of first housing 110 is positioned on the positive Z-axis side of first housing 110 so as to be parallel to the XY plane.

Second housing 120 is elongated along the longitudinal direction of tank 10, and includes second wall portion 123 that is raised from first wall portion 113. As illustrated in FIG. 4, when viewed along the X-axis direction, first wall portion 113 in FIG. 1 and second wall portion 123 are L-shaped. Connectors 31 for electrically connecting to circuit board 30 are attached to second wall portion 123. In the present embodiment, power supply connector 31a for supplying power to circuit board 30 and communication connector 31b for performing communication with circuit board 30 are aligned on second wall portion 123 in the X-axis direction. Power supply connector 31a and communication connector 31b are examples of connectors 31.

When case 40 is viewed along the longitudinal direction of case 40 and the outline of case 40 is defined by a rectangle (indicated by a double-dotted line in FIG. 4), connectors 31 are disposed on second housing 120, at a position within the imaginary rectangular frame indicated by the double-dotted line and adjacent to first housing 110. Connectors 31 protrude from second wall portion 123 in the positive Y-axis direction. The height of each connector 31 is lower than the height of first wall portion 113 in the positive Y-axis direction. Therefore, connectors 31 are positioned within the imaginary rectangular frame indicated by the two dotted lines.

Tank 10 inserted through first opening 112 includes lid 13 that is positioned to cover first opening 112. Lid 13 includes second fastening portion 14 that is fastened to first opening 112. First opening 112 includes second fastened portion 114 that is fastened to second fastening portion 14.

Lid 13 is a plate-shaped member positioned at the end portion of tank 10 on the negative X-axis side. Lid 13 is held on tank 10 at an orientation that is parallel with the YZ plane. In the present embodiment, lid 13 includes a plurality of second fastening portions 14. Second fastening portions 14 are disposed on the edge of lid 13. Therefore, second fastened portions 114 are arranged at first opening 112 on a one-to-one correspondence with second fastening portions 14.

In the present embodiment, second fastening portions 14 and second fastened portions 114 are fastening holes that are fastened by screws, bolts, or the like. Each of second fastening portion 14 and second fastened portion 114 may be, for example, a claw-shaped fastening structure. Moreover, one of second fastening portion 14 or second fastened portion 114 may be a claw-shaped fastening structure, and the other of second fastening portion 114 or second fastened portion 14 may be a hole for hooking the claw. Other known configurations may be used as long as second fastening portions 14 and second fastened portions 114 can be fastened.

In such a manner, first fastening portion 16 and first fastened portion 116 on the positive X-axis side of tank 10 are fastened, and second fastening portion 14 and second fastened portion 114 on the negative X-axis side of tank 10 are fastened. Therefore, tank 10 can be firmly supported by case 40 against not only the collision of an object with the vehicle but also against the vibrations of vehicle driving.

Supply port 11 and discharge port 12 are provided on surface 13a of lid 13. Supply port 11, discharge port 12, and second fastening portions 14 are arranged closely. In other words, second fastening portions 14 are arranged to surround supply port 11 and discharge port 12. Hoses are connected to supply port 11 and discharge port 12, so that the hoses are disposed to extend from lid 13 in the negative X-axis direction. This makes the components included in the vehicle unlikely to come into contact with second fastening portions 14 when the vehicle collides with an object.

Case 40 includes second opening 122 that is open across first housing 110 and second housing 120, on the face of case 40 on the negative Y-axis side. Second opening 122 is an insertion hole for housing circuit board 30 in case 40. Circuit board 30 housed in case 40 is disposed between the plane defined by second opening 122 and tank 10 and across first housing 110 and second housing 120. In other words, as illustrated in FIG. 5, circuit board 30 is positioned across first housing space S1 of first housing 110 and second housing space S2 of second housing 120. Circuit board 30 is held in case 40 so as to be parallel to the plane defined by second opening 122, i.e., parallel to the XZ plane and intersect the imaginary XY plane along slim tank 10.

As illustrated in FIG. 2 and FIG. 5, cover 50 is capable of covering second opening 122 of case 40. Specifically, even though circuit board 30, heating unit 20, and tank 10 are housed in case 40, cover 50 is capable of covering second opening 122 of case 40. Cover 50 is held at second opening 122 of case 40 at an orientation that is parallel to the XZ plane.

For example, as illustrated in FIG. 2, cover 50 includes a plurality of third fastening portions 54. Third fastening portions 54 are disposed on the edge of cover 50. Therefore, third fastened portions 124 are disposed at second opening 122 in a one-to-one correspondence with third fastening portions 54.

In the present embodiment, third fastening portion 54 and third fastened portion 124 are fastening holes fastened by screws, bolts, or the like. Each of third fastening portion 54 and third fastened portion 124 may be, for example, a claw-shaped fastening structure. Moreover, one of third fastening portion 54 or third fastened portion 124 may be a claw-shaped fastening structure, and the other of third fastened portion 124 or third fastening portion 54 may be a hole for hooking the claw. Other known configurations may be adopted as long as third fastening portion 54 and third fastened portion 124 can be fastened.

Fluid heating device 1 for the vehicle may further include thermal interface material 33.

For example, circuit board 30 includes thermal interface material 33 that connects circuit board 30 and case 40. Thermal interface material 33 is capable of transferring the heat from heated circuit board 30 to case 40. In the present embodiment, thermal interface material 33 is disposed between electronic component 30a on the positive Y-axis side of circuit board 30 and second wall portion 123 of second housing 120. Thermal interface material 33 is applied to the surface of electronic component 30a on the positive Y-axis side. Thermal interface material 33 is, for example, heat dissipating silicone.

Fluid heating device 1 for the vehicle may further include detector 32.

For example, circuit board 30 may include detector 32 for detecting leakage of the fluid in case 40. To enable detection of the liquid leakage from tank 10 in case 40, detector 32 is disposed at the end portion of circuit board 30 on the negative Z-axis side, so that a pair of terminals is positioned vertically below circuit board 30.

Circuit board 30 is capable of stopping supplying power to heating unit 20, when detector 32 detects the leakage of the fluid.

Depending on the orientation of fluid heating device 1 for the vehicle when mounted in the vehicle, detector 32 may be disposed at another position on circuit board 30. In other words, detector 32 may be disposed on circuit board 30 such that the fluid leakage can be detected before the fluid reaches circuit board 30 when the fluid leakage occurs.

Fluid heating device 1 for the vehicle may be disposed in the vehicle such that first housing 110 of case 40 is positioned on the front side of the vehicle (e.g., front bumper side) and second housing 120 of case 40 is positioned on the rear side of the vehicle. In this case, when the front of the vehicle collides with an object, and even if first housing 110 of fluid heating device 1 for the vehicle is damaged by the impact, since circuit board 30 is positioned on the rear side of first housing 110, it is expected to prevent circuit board 30, to which high voltage power is supplied, from being damaged. As for connectors 31, since first housing 110, which protrudes further in the positive Y-axis direction relative to connectors 31, is likely to collide with equipment inside the vehicle first, it is expected to prevent connectors 31, to which high-voltage power is supplied, from being damaged. In this case, since supply port 11 and discharge port 12 are disposed on a lateral side of fluid heating device 1 for the vehicle, it is also expected to prevent supply port 11 and discharge port 12 from being damaged.

### <Operational Effects>

Next, the operational effects of fluid heating device 1 for the vehicle according to the present embodiment will be described.

When a vehicle collides with an object, the case of the fluid heating device for the vehicle mounted in the vehicle may be damaged. In this case, the fluid inside the case may leak, affecting the devices inside the vehicle.

In view of the above, as described above, fluid heating device 1 for a vehicle according to technique 1 of the present embodiment, includes: tank 10 that includes a flow path for directing a fluid; heating unit 20 that heats the fluid by heating the tank 10; and case 40 that houses tank 10 and heating unit 20.

With this, tank 10 is better protected because case 40 covers the outer peripheral surface of tank 10 in which the fluid is stored. Therefore, it is expected to protect tank 10 even when case 40 is damaged by a collision between the vehicle and an object.

Therefore, according to the present disclosure, it is possible to prevent the fluid from leaking even when the vehicle collides with an object.

In particular, case 40 is also capable of protecting heating unit 20, which is a high-voltage component, because heating unit 20 is housed in case 40. This is expected to improve the safety in fluid heating device 1 for the vehicle.

Moreover, fluid heating device 1 for the vehicle according to technique 2 of the present embodiment is fluid heating device 1 for the vehicle according to technique 1. In this case, heating unit 20 is disposed in tank 10.

This allows heating unit 20 to heat tank 10, thus warming the fluid directed inside tank 10. As a result, a vehicle air conditioning device is capable of using the heated fluid to deliver warm air into the vehicle cabin when performing a heating operation.

Moreover, fluid heating device 1 for the vehicle according to technique 3 of the present embodiment is fluid heating device 1 for the vehicle according to technique 1 or 2. In this case, tank 10 is elongated, case 40 includes first housing 110 that houses tank 10, first housing 110 being elongated, first housing 110 includes first opening 112 at a first longitudinal end portion of first housing 110, and, first opening 112 is open to allow tank 10 to be inserted.

Tank 10 and case 40 according to the present embodiment are elongated in the X-axis direction. However, for example, when the first opening is provided along the longitudinal direction of the case, the number of fastening portions and fastened portions for fastening the tank and the case would increase.

However, in the present embodiment, tank 10 is inserted from a lateral face of case 40, i.e., first opening 112 is provided on the lateral face of tank 10 (first longitudinal end portion of tank 10). Therefore, it is difficult to increase the area of the opening of first opening 112. As a result, it is possible to prevent the number of fastening portions and fastened portions (second fastening portions 14 and second fastened portions 114) for connecting first opening 112 and tank 10 from increasing.

In addition, an increase in the number of fastening portions and fastened portions (second fastening portion 14 and second fastened portion 114) can be reduced, so that an increase in the number of fastening members such as screws, bolts, or the like can also be reduced. As a result, it is possible to reduce an increase in the number of component, assembling steps, and weight in fluid heating device 1 for the vehicle.

Fluid heating device 1 for the vehicle according to technique 4 of the present embodiment is fluid heating device 1 for the vehicle according to any one of techniques 1 to 3. In this case, case 40 includes: first housing 110 that is elongated in a first direction, extends in a second direction intersecting the first direction, and houses tank 10; second housing 120 that is elongated along a longitudinal direction of first housing 110, is connected to first housing 110, and extends in a third direction intersecting the first direction and the second direction, fluid heating device 1 for the vehicle includes connector 31, and when case 40 is viewed along a longitudinal direction of case 40, and an outline of case 40 is defined by an imaginary rectangular frame, connector 31 is disposed on second housing 120, in a position within the imaginary rectangular frame and adjacent to first housing 110.

This allows connectors 31 to be positioned at the corner portion formed by the L-shaped first and second housings 110 and 120 to prevent connectors 31 from protruding outward beyond the imaginary rectangular frame. This prevents the size of fluid heating device 1 for the vehicle from increasing.

In addition, connectors are usually made of resin members. The connectors are likely to be damaged when a vehicle collides with an object. The connectors are in a high voltage state to supply power to the heating unit. If the connectors are damaged, leakage of electricity from the connectors could occur. For this reason, the connectors should be protected by a strong case.

In view of the above, in the present embodiment, connectors 31 are positioned such that connectors 31 do not protrude beyond the imaginary rectangular frame of case 40. By doing so, it is considered that case 40 will collide with the equipment inside the vehicle first, when the vehicle collides with an object. Therefore, connectors 31 are expected to be protected.

Moreover, fluid heating device 1 for the vehicle according to technique 5 of the present embodiment is fluid heating device 1 for the vehicle according to technique 4. In this case, first housing 110 includes first wall portion 113 that is elongated along a longitudinal direction of tank 10, first wall portion 113 being connected to second housing 120, second housing 120 includes second wall portion 123 that is elongated along the longitudinal direction of tank 10, second wall portion 123 being raised from first wall portion 113, and connector 31 is attached to second wall portion 123.

This allows connectors 31 to be positioned on second wall portion 123. Therefore, connectors 31 can be disposed within the imaginary rectangle and at the corner portion formed by the L-shaped first wall portion 113 and second wall portion 123. This prevents the size of fluid heating device 1 for the vehicle from increasing.

In addition, since it is considered that case 40 will be damaged first when the vehicle collides with an object, connectors 31 are expected to be protected.

Moreover, fluid heating device 1 for the vehicle according to technique 6 of the present embodiment is fluid heating device 1 for the vehicle according to any one of techniques 3 to 5. In this case, first housing 110 includes: first opening 112 at a first longitudinal end portion of first housing 110, and first bottom portion 111 at a second longitudinal end portion of first housing 110. First bottom portion 111 includes first guide portion 117, tank 10 includes second guide portion 17 at front end portion 15 of tank 10 in a direction in which tank 10 is inserted into first opening 112, and first guide portion 117 guides second guide portion 17 of tank 10 inserted through first opening 112.

With this, when tank 10 is inserted from first opening 112 of case 40 along the positive X-axis direction, first guide portion 117 on front end portion 15 of tank 10 is guided to second guide portion 17 on first bottom portion 111 of case 40. The engagement of first guide portion 117 and second guide portion 17 allows front end portion 15 of tank 10 to be held at a predetermined orientation.

Moreover, fluid heating device 1 for the vehicle according to technique 7 of the present embodiment is fluid heating device 1 for the vehicle according to any one of techniques 3 to 6. In this case, first housing 110 includes: first opening 112 at a first longitudinal end portion of first housing 110; and first bottom portion 111 at a second longitudinal end portion of first housing 110. Tank 10 includes first fastening portion 16 at front end portion 15 of tank 10 in a direction in which tank 10 is inserted into first opening 112. First bottom portion 111 includes first fastened portion 116 to be fastened to first fastening portion 16.

With this, first guide portion 117 and second guide portion 17 are engaged to maintain front end portion 15 of tank 10 at a predetermined orientation such that first fastening portion 16 and first fastened portion 116 can be fastened. Therefore, front end portion 15 of tank 10 can be fixed to first bottom portion 111 by fastening first fastening portion 16 and first fastened portion 116.

In addition, when tank 10 is inserted into case 40, second guide portion 17 contacts case 40, thus preventing heating unit 20 from being damaged at the time of insertion of tank 10 into case 40.

Moreover, fluid heating device 1 for the vehicle according to technique 8 of the present embodiment is fluid heating device 1 for the vehicle according to any one of techniques 3 to 7. In this case, fluid heating device 1 for the vehicle includes heat insulation layer K between heating unit 20 and an inner wall surface of first housing 110.

With this, heat insulation layer K is provided between cover 50 and tank 10, so that heated tank 10 can be thermally insulated by heat insulation layer K, making the heat from tank 10 less likely to be escaped into case 40.

Moreover, fluid heating device 1 for the vehicle according to technique 9 of the present embodiment is fluid heating device 1 for the vehicle according to technique 8. In this case, heat insulation layer K is an air layer.

With this, an air layer is provided between cover 50 and tank 10, so that heated tank 10 can be thermally insulated by the air layer, making the heat from tank 10 less likely to be escaped into case 40. Moreover, by providing the air layer, it is possible to prevent the weight of fluid heating device 1 for the vehicle from increasing and the manufacturing cost of fluid heating device 1 for the vehicle from increasing due to an increase in the number of components.

Moreover, fluid heating device 1 for the vehicle according to technique 10 of the present embodiment is fluid heating device 1 for the vehicle according to any one of techniques 1 to 9. In this case, fluid heating device 1 for the vehicle further includes circuit board 30 that is housed in case 40 to drive and control heating unit 20. Tank 10 is slim in a first direction and elongated, and circuit board 30 is held in case 40 at an orientation that intersects an imaginary plane (XY plane) that is perpendicular to the first direction.

This allows circuit board 30 to stand relative to slim tank 10, thus ensuring the distance between circuit board 30 and tank 10. This reduces the effects of heat from heated tank 10.

The distance between circuit board 30 and tank 10 is secured. However, on the other hand, circuit board 30 and tank 10 are also in a distance relationship that allows direct connection between the connection terminals of circuit board 30 and the connection terminals of heating unit 20 in order for circuit board 30 to supply power to heating unit 20. Therefore, in the present embodiment, circuit board 30 and tank 10 are arranged in such a manner that achieves both a reduction of the effects of heat from tank 10 to circuit board 30 and the electrical connection between circuit board 30 and heating unit 20.

Since circuit board 30 is disposed in second housing 120, circuit board 30 is disposed adjacent to second wall portion 123 of second housing 120. Therefore, the heat emitted from circuit board 30 is more likely to be transferred to second wall portion 123, and is more likely to be dissipated from circuit board 30.

The heat emitted from circuit board 30 can also be transferred to the lateral sides of tank 10.

Moreover, fluid heating device 1 for the vehicle according to technique 11 of the present embodiment is fluid heating device 1 for the vehicle according to any one of techniques 1 to 9. In this case, fluid heating device 1 further includes: circuit board 30 that is housed in case 40 to drive and control heating unit 20. Case 40 includes: first housing 110 that is elongated in a first direction, extends in a second direction intersecting the first direction, and houses tank 10; and second housing 120 that is elongated along a longitudinal direction of first housing 110, is connected to first housing 110, and extends in a third direction intersecting the first direction and the second direction, and circuit board 30 is disposed across first housing space S1 of first housing 110 and second housing space S2 of second housing 120.

This allows circuit board 30 to be positioned across a space different from first housing space S1 (second housing space S2) in which tank 10 is disposed, while circuit board 30 is arranged to stand relative to slim tank 10. Therefore, the distance between circuit board 30 and tank 10 can be secured. This reduces the effects of heat from heated tank 10.

Moreover, since circuit board 30 is disposed in second housing 120, circuit board 30 is disposed adjacent to second wall portion 123 of second housing 120. Therefore, the heat emitted from circuit board 30 is transferred to second wall portion 123, making the heat more likely to be dissipated from circuit board 30.

Moreover, fluid heating device 1 for the vehicle according to technique 12 of the present embodiment is fluid heating device 1 for the vehicle according to any one of techniques 1 to 9. In this case, fluid heating device 1 for the vehicle further includes: circuit board 30 that is housed in case 40 to drive and control heating unit 20. Case 40 includes: first housing 110 that is elongated in a first direction, extends in a second direction intersecting the first direction, and houses tank 10; and second housing 120 that is elongated along a longitudinal direction of first housing 110, is connected to first housing 110, and extends in a third direction intersecting the first direction and the second direction, and case 40 includes second opening 122 to which circuit board 30 is inserted, second opening 122 being provided across first housing 110 and second housing 120, and circuit board 30 is disposed between a plane defined by second opening 122 and tank 10, and is held in case 40 at an orientation that is parallel to the plane defined by second opening 122.

This allows fluid heating system 1 for the vehicle to be disposed in the vehicle such that first housing 110 is positioned on the front side of the vehicle and second housing 120 is positioned on the rear side of the vehicle. Even when the front side of the vehicle collides with an object, first housing 110 will hit the equipment inside the vehicle first. At this time, even when first housing 110 is damaged, it is expected that circuit board 30 positioned on the rear side of the vehicle will not be damaged.

Moreover, fluid heating device 1 for the vehicle according to technique 13 of the present embodiment is fluid heating device 1 for the vehicle according to any one of techniques 1 to 9. In this case, fluid heating device 1 for the vehicle further includes: circuit board 30 that is housed in case 40 to drive and control heating unit 20; and thermal interface material 33 that connects circuit board 30 and case 40.

With this, even when circuit board 30 generates heat by driving and controlling heating unit 20, thermal interface material 33 is capable of releasing the heat to case 40. This reduces an increase in the temperature of circuit board 30.

Moreover, fluid heating device 1 for the vehicle according to technique 14 of the present embodiment is fluid heating device 1 for the vehicle according to any one of techniques 1 to 13. In this case, case 40 includes first housing 110 that is elongated and houses tank 10; first housing 110 includes first opening 112 at a first longitudinal end portion of first housing 110; tank 10 includes lid 13 that covers first opening 112 when tank 10 is inserted through first opening 110. Lid 13 is integrated with tank 10, and includes second fastening portion 14 that is fastened to first opening 112, and first opening 112 includes second fastened portion 114 that is fastened to second fastening portion 14.

This allows lid 13 integrated with tank 10 to be fastened to first opening 112 to seal first opening 112, eliminating the need for a separate component to cover first opening 112. As a result, an increase in the number of components, assembling steps, and weight of fluid heating system 1 for the vehicle can be reduced.

Furthermore, once first fastening portion 16 and first fastened portion 116 are fastened, front end portion 15 of tank 10 can be fixed to first bottom portion 111, allowing tank 10 to be more firmly supported by case 40. In other words, tank 10 can be firmly supported by case 40 against vehicle vibrations because the end portion of tank 10 on the positive X-axis side and the end portion of tank 10 on the negative X-axis side are fastened to case 40.

Moreover, fluid heating device 1 for the vehicle according to technique 15 of the present embodiment is fluid heating device 1 for the vehicle according to technique 14. In this case, tank 10 includes: supply port 11 through which the fluid is supplied into tank 10 from outside tank 10; and discharge port 12 through which the fluid having passed through the flow path of tank 10 is discharged to the outside tank 10, and supply port 11 and discharge port 12 are provided on surface 13a of lid 13.

This allows supply port 11 and discharge port 12 to be provided on the same surface 13a of lid 13, thus reducing an increase of the external size of tank 10 compared to when supply port 11 and discharge port 12 are provided on different surfaces.

Moreover, supply port 11 and discharge port 12 can be provided on the same surface 13a, allowing the fluid supplied from supply port 11 to make a U-turn in tank 10 and to be discharged from discharge port 12. This allows the flow path length from supply port 11 to discharge port 12 to be as long as possible. As a result, heating of the fluid in tank 10 by heating unit 20 is facilitated.

Moreover, fluid heating device 1 for the vehicle according to technique 16 of the present embodiment is fluid heating device 1 for the vehicle according to technique 15. In this case, supply port 11, discharge port 12, and second fastening portion 14 are closely arranged.

With this, hoses are connected to supply port 11 and discharge port 12, so that the hoses extend from lid 13. Since the hoses are disposed, no equipment is disposed around the hoses in the vehicle, and it is possible to prevent second fastening portion 14 from coming into contact with the equipment inside the vehicle. In addition, when the vehicle collides with an object, the equipment inside the vehicle is more likely to collide with the protruding hoses. This prevents second fastening portion 14 from colliding with the equipment inside the vehicle, thus preventing second fastening portion 14 and lid 13 from being damaged.

Moreover, fluid heating device 1 for the vehicle according to technique 17 of the present embodiment is fluid heating device 1 for the vehicle according to any one of techniques 1 to 16. In this case, fluid heating device 1 for the vehicle further includes: circuit board 30 that is housed in case 40 to drive and control heating unit 20. Circuit board 30 includes detector 32 that detects a leakage of the fluid in case 40, and circuit board 30 stops supplying power to heating unit 20 when detector 32 detects the leakage of the fluid.

With this, even when water leakage from tank 10 occurs, it is possible for detector 32 to detect the leakage. As a result, circuit board 30 is capable of stopping supplying power to heating unit 20 before circuit board 30 and heating unit 20 are exposed to water.

### (Other Variations)

Although the fluid heating device for the vehicle according to the present disclosure has been described based on the embodiment, the present disclosure is not limited to the embodiment. Various modifications to the embodiment that can be conceived by those skilled in the art without departing from the teachings of the present disclosure are also included in the scope of the present disclosure.

In addition, a form obtained making various modifications conceivable by those skilled in the art to the embodiment described above, and a form realized by arbitrarily combining the structural elements and functions in the embodiment without departing from the teachings of the present disclosure are also included in the present disclosure.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims are incorporated herein by reference in their entirety: Japanese Patent Application No. 2024-026181 filed on Feb. 26, 2024.

### INDUSTRIAL APPLICABILITY

The present disclosure is usable for a fluid heating device for a vehicle, such as an air conditioning device mounted in the vehicle.

1. A fluid heating device for a vehicle, comprising:
a tank that includes a flow path for directing a fluid;
a heating unit that heats the fluid by heating the tank; and
a case that houses the tank and the heating unit.

2. The fluid heating device for the vehicle according to claim 1,
wherein the heating unit is disposed in the tank.

3. The fluid heating device for the vehicle according to claim 1,
wherein the tank is elongated,
the case includes a first housing that houses the tank, the first housing being elongated,
the first housing includes a first opening at a first longitudinal end portion of the first housing, and
the first opening is open to allow the tank to be inserted.

4. The fluid heating device for the vehicle according to claim 1,
wherein the case includes:
a first housing that is elongated in a first direction, extends in a second direction intersecting the first direction, and houses the tank; and
a second housing that is elongated along a longitudinal direction of the first housing, is connected to the first housing, and extends in a third direction intersecting the first direction and the second direction,
the fluid heating device for the vehicle comprises a connector, and
when the case is viewed along a longitudinal direction of the case, and an outline of the case is defined by an imaginary rectangular frame, the connector is disposed on the second housing, in a position within the imaginary rectangular frame and adjacent to the first housing.

5. The fluid heating device for the vehicle according to claim 4,
wherein the first housing includes a first wall portion that is elongated along a longitudinal direction of the tank, the first wall portion being connected to the second housing,
the second housing includes a second wall portion that is elongated along the longitudinal direction of the tank, the second wall portion being raised from the first wall portion, and
the connector is attached to the second wall portion.

6. The fluid heating device for the vehicle according to claim 3,
wherein the first housing includes:
a first opening at a first longitudinal end portion of the first housing; and
a first bottom portion at a second longitudinal end portion of the first housing,
the first bottom portion includes a first guide portion,
the tank includes a second guide portion at a front end portion of the tank in a direction in which the tank is inserted into the first opening, and
the first guide portion guides the second guide portion of the tank inserted through the first opening.

7. The fluid heating device for the vehicle according to claim 3,
wherein the first housing includes:
a first opening at a first longitudinal end portion of the first housing; and
a first bottom portion at a second longitudinal end portion of the first housing,
the tank includes a first fastening portion at a front end portion of the tank in a direction in which the tank is inserted into the first opening, and
the first bottom portion includes a first fastened portion to be fastened to the first fastening portion.

8. The fluid heating device for the vehicle according to claim 3, further comprising:
a heat insulation layer between the heating unit and an inner wall surface of the first housing.

9. The fluid heating device for the vehicle according to claim 8,
wherein the heat insulation layer is an air layer.

10. The fluid heating device for the vehicle according to claim 1, further comprising:
a circuit board that is housed in the case to drive and control the heating unit,
wherein the tank is slim in a first direction and elongated, and
the circuit board is held in the case at an orientation that intersects an imaginary plane that is perpendicular to the first direction.

11. The fluid heating device for the vehicle according to claim 1, further comprising:
a circuit board that is housed in the case to drive and control the heating unit,
wherein the case includes:
a first housing that is elongated in a first direction, extends in a second direction intersecting the first direction, and houses the tank; and
a second housing that is elongated along a longitudinal direction of the first housing, is connected to the first housing, and extends in a third direction intersecting the first direction and the second direction, and
the circuit board is disposed across a first housing space of the first housing and a second housing space of the second housing.

12. The fluid heating device for the vehicle according to claim 1, further comprising:
a circuit board that is housed in the case to drive and control the heating unit,
wherein the case includes:
a first housing that is elongated in a first direction, extends in a section direction intersecting the first direction, and houses the tank; and
a second housing that is elongated along a longitudinal direction of the first housing, is connected to the first housing, and extends in a third direction intersecting the first direction and the second direction, and
the case includes a second opening to which the circuit board is inserted, the second opening being provided across the first housing and the second housing, and
the circuit board is disposed between a plane defined by the second opening and the tank, and is held in the case at an orientation that is parallel to the plane defined by the second opening.

13. The fluid heating device for the vehicle according to claim 1, further comprising:
a circuit board that is housed in the case to drive and control the heating unit; and
a thermal interface material that connects the circuit board and the case.

14. The fluid heating device for the vehicle according to claim 1,
wherein the case includes a first housing that is elongated, and houses the tank,
the first housing includes a first opening at a first longitudinal end portion of the first housing,
the tank includes a lid that covers the first opening when the tank is inserted through the first opening,
the lid is integrated with the tank, and includes a second fastening portion that is fastened to the first opening, and
the first opening includes a second fastened portion that is fastened to the second fastening portion.

15. The fluid heating device for the vehicle according to claim 14,
wherein the tank includes: a supply port through which the fluid is supplied into the tank from outside the tank; and a discharge port through which the fluid having passed through the flow path of the tank is discharged to the outside the tank, and
the supply port and the discharge port are provided on a surface of the lid.

16. The fluid heating device for the vehicle according to claim 15,
wherein the supply port, the discharge port, and the second fastening portion are closely arranged.

17. The fluid heating device for the vehicle according to claim 1, further comprising:
a circuit board that is housed in the case to drive and control the heating unit,
wherein the circuit board includes a detector that detects a leakage of the fluid in the case, and
the circuit board stops supplying power to the heating unit when the detector detects the leakage of the fluid.
